(19) United States
(12) Patent Application Publication
(10) Pub. No.: US 2026/0326211 A1
(43) Pub. Date: Oct. 22, 2026

(54) Acoustic-based Drill Optimization

(71) Applicant: Kira Mary Kathleen Overton, Thunder Bay (CA)

(72) Inventor: Kira Mary Kathleen Overton, Thunder Bay (CA)

(21) Appl. No.: 19/181,397

(22) Filed: Apr. 17, 2025

(51) Int. Cl. B23B 49/00

(52) U.S. Cl. CPC B23B 49/00; B23B 2270/48

(57) ABSTRACT

A system and method for optimizing drill operations using acoustic analysis are disclosed. The system includes one or more microphones positioned externally capture drilling-generated acoustic signals and an analog-to-digital converter converts the captured signals into digital data. A processor executes a machine learning model trained to analyze the digital data and determine drilling conditions. The system provides real-time feedback on drilling parameters, including feed rate, rotation speed, air or water pressure, hole openness, breakthrough, ground support, fractures, and voids. A feedback device presents suggested adjustments to an operator via a visual display, auditory alerts, or haptic feedback, while a communication module enables wireless transmission of drilling data to a remote monitoring system, a teleoperated drilling control system, or an automated drilling control system. The machine learning model continuously updates based on real-time data, improving predictive accuracy and optimizing drilling efficiency without requiring drill retrofitting.

### BACKGROUND OF THE INVENTION

The present invention relates to an acoustic-based drill optimization system. More particularly, the present invention provides a system and method for optimizing drill operations through acoustic analysis using machine learning. The system is designed to analyze drilling sounds, interpret drilling conditions, and provide real-time feedback to improve drilling efficiency and performance.

In conventional drilling operations, experienced drillers rely on auditory cues to assess drilling conditions, such as changes in material hardness, bit wear, and breakthrough events. This expertise is acquired over years of experience and is critical for optimizing drilling parameters, including feed rate, rotation speed, and air or water pressure. However, newer or less-experienced operators may lack the ability to interpret these auditory cues effectively, leading to suboptimal performance, increased wear on equipment, and reduced drilling efficiency. Additionally, remote and automated drilling systems do not inherently possess the ability to “hear” and interpret drilling sounds as a human operator would.

The present invention provides a solution by utilizing a system that captures and analyzes acoustic signals generated during drilling operations. The system includes one or more microphones positioned near the drill, an analog-to-digital converter to process sound data, and a processor executing a machine learning model trained to interpret acoustic signatures indicative of drilling conditions. By leveraging real-time acoustic data, the system can suggest parameter adjustments to improve drilling efficiency, detect abnormal conditions such as fractures or voids, and enhance automated drilling control.

Unlike existing solutions that rely on physical sensors integrated into the drill, the present invention does not require retrofitting or modifications to the drill itself. Instead, it operates as an independent system, allowing for easy deployment across various drilling applications, including underground long hole drilling in mining operations and deep foundation drilling for construction. The system can assist both human operators and autonomous drilling platforms by providing real-time insights based on sound analysis, thereby enhancing safety, efficiency, and production metrics.

In light of existing drilling optimization methods, the present invention substantially diverges in design and approach from conventional systems. By applying machine learning to acoustic data, it offers a novel and effective means of optimizing drilling performance without requiring years of operator experience or costly drill modifications. In this regard, the instant invention substantially fulfills the need for an improved drilling optimization system.

### SUMMARY OF THE INVENTION

In view of the foregoing challenges inherent in conventional drill optimization methods, the present invention provides a new acoustic-based drill optimization system that enables real-time assessment of drilling conditions using machine learning and acoustic analysis.

It is an objective of the present invention to provide a system for optimizing drill operations by analyzing drilling-generated acoustic signals and using a trained machine learning model to identify drilling conditions, including optimal feed rate, rotation speed, air or water pressure, hole openness, breakthrough, ground support, fractures, and voids.

In one embodiment, the system provides a standalone acoustic monitoring solution that does not require retrofitting of existing drills. The system includes one or more microphones positioned near a drill to capture sound signals, an analog-to-digital converter to process these signals, and a processor executing a machine learning model trained to analyze and interpret the sounds in real time.

The system comprises a feedback device configured to provide real-time operational guidance to a drill operator. The feedback may be presented via a visual display, auditory alerts, or a combination thereof. The system also includes a communication module capable of transmitting data to a remote monitoring interface or an automated drilling control system.

In one embodiment, the machine learning model is trained using historical acoustic data correlated with optimal drilling performance metrics. The system continuously updates based on real-time drilling data, improving predictive accuracy over time.

In another embodiment, the system detects abnormal drilling sounds indicative of equipment failure, geological anomalies, or drill bit wear. Upon detection, the system can generate alerts and suggest corrective actions to the operator.

In yet another embodiment, the system is integrated into a teleoperated drilling control platform, where it transmits optimized drilling parameter recommendations to enhance remote drilling efficiency. In yet another embodiment, the system transmits collected acoustic data to a cloud-based storage system for further analysis and refinement of the machine learning model.

In yet another embodiment, the processor executes a pre-trained machine learning model that classifies drilling conditions based on frequency spectrum analysis of the captured sound data.

It is therefore an objective of the present invention to provide a new and improved drill optimization system that leverages acoustic data and machine learning to enhance drilling efficiency while reducing reliance on human expertise and costly drill modifications.

It is therefore an object of the present invention to provide a new and improved acoustic-based drill optimization system that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a block diagram of the acoustic-based drill optimization system.

FIG. 2 shows a schematic diagram of the system in use, with microphones positioned near a drill to capture acoustic signals, and a display interface providing real-time feedback to an operator based on detected drilling conditions.

### DETAILED DESCRIPTION OF THE INVENTION

Reference is made herein to the attached drawings. For the purpose of presenting a brief and clear description of the present invention, the described embodiment will be discussed as used for optimizing drill operations through acoustic analysis and machine learning. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

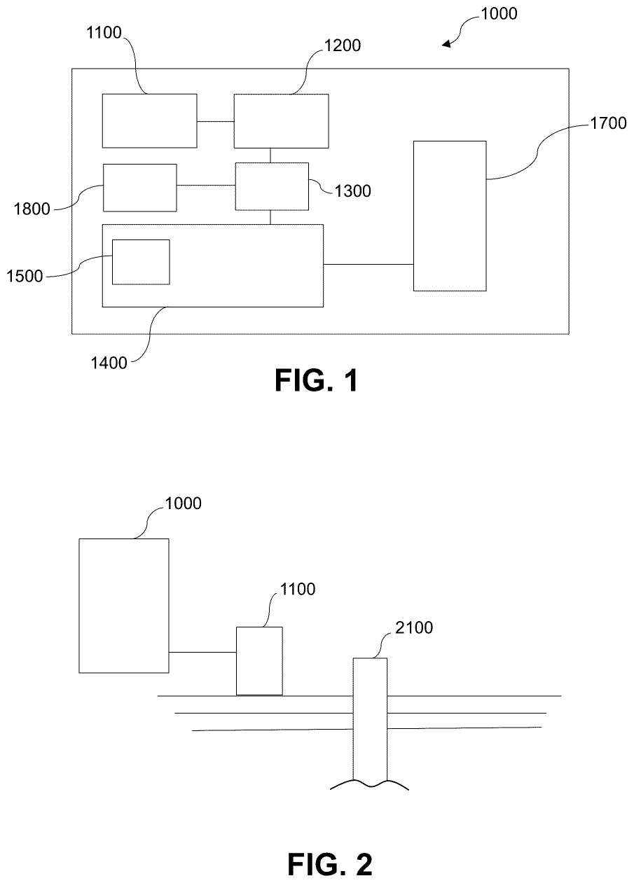

Referring now to FIG. 1, there is shown a block diagram of an acoustic-based drill optimization system 1000. The acoustic-based drill optimization system 1000 is configured to analyze drilling-generated acoustic signals and provide real-time feedback to optimize drilling performance. In one embodiment, the acoustic-based drill optimization system 1000 operates as an independent monitoring solution that does not require modifications to the drill itself. The system 1000 is adapted for use in ore drilling operations, underground mining, and deep foundation drilling where experienced operators rely on auditory cues to assess drilling conditions. The present invention automates the process of changing parameters, such as feed rate and rotation speed of the bit as it detects changes in drilling sounds. In some embodiments, machine learning is used to identify drilling conditions based on sound data, thereby providing real-time guidance that enhances drilling efficiency, extends equipment lifespan, and reduces operational risks.

The system 1000 comprises includes one or more microphones 1100 positioned proximate to a drill to capture acoustic signals generated during drilling operations. The microphones 1100 are configured to detect a range of sound frequencies associated with drilling conditions, such as vibrations, material fractures, and changes in rock hardness. These microphones 1100 are electrically connected to an analog-to-digital converter 1200, which converts the captured analog acoustic signals into digital data. The analog-to-digital converter 1200 transmits the digitized acoustic data to a processor 1300, which is in electronic communication with the converter 1200 and executes instructions stored in a non-transitory memory storage 1400. The non-transitory memory storage 1400 contains machine-readable instructions that, when executed by the processor 1300, cause the system 1000 to analyze the digital data using a machine learning model 1500.

In some embodiments, the non-transitory memory storage 1400 is housed within a local computing device, such as an on-site industrial computer or a portable ruggedized computing unit located near the drilling operation. In other embodiments, the non-transitory memory storage 1400 may be implemented within a cloud-based computing system, where the processor 1300 transmits acoustic data to a remote server for processing. The cloud-based system enables real-time analysis and model updates across multiple drilling sites, allowing for centralized data aggregation and predictive analysis. Additionally, hybrid configurations may be used, where real-time processing occurs locally while long-term data storage and model refinement are handled remotely via a cloud platform.

In one embodiment, the machine learning model 1500 is trained to recognize acoustic signatures associated with different drilling conditions. Upon analyzing the data, the model 1500 identifies relevant drilling conditions and determines whether any adjustments to drilling parameters are necessary. Based on the identified conditions, the processor 1300 generates real-time feedback 1600 to optimize drilling operations. As used herein, the “machine learning model 1500” refers to a computational model trained to analyze acoustic data and identify drilling conditions based on recognized sound patterns. This model is implemented using supervised, unsupervised, or reinforcement learning techniques, where it is trained on historical drilling data, including acoustic signatures associated with optimal and suboptimal drilling conditions. The machine learning model 1500 is implemented through a series of trained algorithms executed by the processor 1300. When acoustic data is received, the processor 1300 applies feature extraction techniques, such as frequency spectrum analysis, waveform pattern recognition, and anomaly detection, to compare the incoming signals with stored patterns. Based on these comparisons, the machine learning model 1500 classifies the drilling conditions and determines whether adjustments are needed to optimize performance.

In one embodiment, the machine learning model 1500 is trained using historical acoustic data that has been correlated with optimal drilling performance metrics. This includes datasets from past drilling operations, where specific acoustic signatures were linked to high-efficiency drilling conditions, minimal bit wear, and reduced energy consumption. Moreover, in some embodiments, the machine learning model 1500 classifies drilling conditions based on frequency spectrum analysis of the digital data. The system 1000 applies signal processing techniques such as Fourier transforms and spectrogram analysis to extract frequency-domain features that correspond to specific drilling conditions.

In one embodiment, the machine learning model 1500 can be periodically updated to improve accuracy over time. In some embodiments, real-time drilling data collected by the system 1000 is transmitted via the communication module 1800 to a cloud-based repository, where new acoustic samples are analyzed, and the model is retrained using the latest drilling conditions. These updates may be automatically deployed to the local system, ensuring that the model remains optimized for changing geological conditions and drill configurations.

In another embodiment, the real-time feedback 1600 is communicated to an operator via a feedback device 1700, which may include a visual display, auditory alerts, or haptic feedback mechanisms. The feedback device 1700 is designed to provide real-time operational guidance through multiple sensory channels, ensuring that the operator receives clear and actionable information. In one embodiment, the visual feedback is presented on an LCD, LED, or touchscreen display integrated into a control panel or a standalone interface. This display can show parameter recommendations such as feed rate and rotation speed adjustments, as well as warnings related to equipment wear or geological anomalies. In some embodiments, the feedback device 1700 includes an auditory output, such as a speaker system or a headset-compatible module, which provides verbal alerts or tone-based signals that indicate critical drilling conditions. Additionally, for environments with high noise levels, the feedback device 1700 may include haptic feedback mechanisms, such as vibrational alerts embedded in a handheld unit or operator gloves, to notify the operator of necessary adjustments without relying on visual or auditory cues. The feedback device 1700 may also be equipped with a wireless communication interface, allowing real-time transmission of feedback data to remote operators or teleoperated drilling control systems. Furthermore, the system may allow customization of alerts based on operator preferences, enabling users to adjust sensitivity levels, select

The system 1000 further includes a communication module 1800 that transmits real-time feedback to a remote monitoring system or an automated drilling control system. In some embodiments, the communication module 1800 transmits captured acoustic data to a cloud-based storage system for additional analysis and refinement of the machine learning model 1500. The system 1000 operates independently of the drill, allowing for deployment across various drilling environments without requiring physical modifications to the drill itself. The ability to analyze acoustic data in real time provides both experienced and novice drill operators with actionable insights, thereby improving drilling efficiency and reducing reliance on operator intuition. In one embodiment, the communication module 1800 includes a wireless transceiver configured to transmit data to a remote drilling control interface. The transceiver enables seamless integration with cloud-based monitoring systems and remote operators.

In one exemplary use, the system 1000 is used in remote and automated drilling applications, where operators may not be physically present at the drilling site. By analyzing acoustic signals in real time and transmitting feedback to a remote monitoring system or an automated drilling control system, the system 1000 provides feedback for remote or teleoperated drilling operations.

The present invention provides a drilling optimization system that operates independently of the drill structure, eliminating the need for physical retrofitting. As used herein, “physical retrofitting” refers to any modification, alteration, or integration of additional components into the drill's mechanical, electrical, or structural system to accommodate new functionality. This includes, but is not limited to, the installation of sensors, additional circuitry, external housings, or mechanical modifications to the drill body or drill string. Unlike traditional optimization systems that require such modifications, the present invention relies solely on externally placed microphones and computational analysis, ensuring compatibility across various drilling platforms without altering the drill itself.

Referring now to FIG. 2, there is shown a schematic diagram of the acoustic-based drill optimization system 1000 in use during a drilling operation. The system 1000 is deployed in proximity to a drill rig 2100, where one or more microphones 1100 are positioned near the drilling site to capture acoustic signals generated during drilling operations. The microphones 1100 may be mounted on tripods or other external supports such that the system 1000 operates independently of the drill structure. In some embodiments, the microphones are disposed subterranean.

In one exemplary use, the system 1000 is employed in a teleoperated drilling environment, where the operator is located remotely and relies on real-time acoustic data for decision-making. The system 1000 transmits feedback and drilling recommendations to the operator via a remote control interface, enabling enhanced precision in remote drilling operations.

In one embodiment, the system 1000 is implemented in an underground long hole drilling scenario, where a drill rig 2100 performs production drilling in a mining environment. The microphones 1100 detect acoustic signals that indicate changes in drilling conditions, such as rock hardness variations, fractures, voids, or equipment wear. The captured acoustic data is then processed by the analog-to-digital converter 1200, which converts the signals into digital data for further analysis. The processor 1300 executes machine-readable instructions stored in the non-transitory memory storage 1400 to analyze the digitized acoustic signals using the machine learning model 1500. The machine learning model 1500 is trained to identify drilling conditions based on acoustic patterns, including optimal feed rate, rotation speed, air or water pressure, hole openness, breakthrough, ground support conditions, fractures, and voids. In one embodiment, the machine learning model 1500 is configured to differentiate between various drilling environments, such as ore drilling and bedrock drilling for structural foundations. The model adapts its analysis and feedback based on the geological conditions detected in the acoustic data.

Based on the analyzed acoustic data, the processor 1300 generates real-time feedback 1600, which is provided to the drill operator through a feedback device 1700. The feedback device 1700 may present visual indicators on a display screen, auditory alerts, or haptic feedback to suggest modifications to drilling parameters. In some embodiments, the feedback device 1700 provides operator-specific recommendations by recognizing distinct drilling patterns and adjusting feedback accordingly. In some embodiments, the machine learning model 1500 is configured to recognize operator-specific drilling patterns. By analyzing past operator inputs and adjustments, the system 1000 can provide personalized recommendations tailored to the user's drilling style, improving efficiency over time.

In automated drilling applications, the communication module 1800 transmits the real-time feedback 1600 to a remote monitoring system 2000. This allows for autonomous parameter adjustments based on the machine learning model's predictions, reducing the need for manual operator intervention. In one embodiment, the system 1000 detects abnormal acoustic signatures, such as those associated with equipment failure, geological anomalies, or drill bit wear. If an anomaly is detected, the system generates a predictive maintenance alert, notifying the operator or remote monitoring system of potential issues before they lead to significant equipment downtime. Additionally, the system 1000 generates a predictive maintenance alert. These alerts may be displayed on the feedback device 1700 or transmitted via the communication module 1800 to a remote monitoring system or an automated drilling control system 2000. The alerts enable proactive maintenance, allowing operators to address potential failures before they result in costly downtime or equipment damage.

By leveraging machine learning and acoustic analysis, the acoustic-based drill optimization system 1000 enhances drilling efficiency, reduces equipment wear, and minimizes operator reliance on intuition. The system provides real-time feedback, remote monitoring capabilities, predictive maintenance alerts, and adaptive learning, making it a versatile and valuable tool for a wide range of drilling applications.

In one embodiment, the machine learning model 1500 is configured to detect abnormal drilling conditions by analyzing acoustic anomalies such as frequency spectrum shifts, increased high-frequency noise, loss of low-frequency stability, harmonic distortions, amplitude variations, and transient acoustic events. These anomalies may indicate mechanical degradation, drill bit wear, or subsurface changes that could impact drilling efficiency. The system 1000 establishes baseline frequency profiles using historical drilling data stored in non-transitory memory storage 1400 and compares them to real-time acoustic data. Deviations, such as unexpected harmonic distortions or amplitude spikes, are classified by the processor 1300, which determines whether they represent normal operational fluctuations or potential failure conditions.

The system 1000 identifies amplitude variations and transient acoustic events that may signal mechanical issues. Gradual increases in amplitude often correlate with drill bit wear, while intermittent spikes suggest momentary slippage or instability. Conversely, a loss of consistent tonal elements may indicate lubrication failure or structural fatigue. Additionally, transient events such as clicking sounds from rock fractures, grinding noises due to excessive friction, and rhythmic pulsing indicative of mechanical misalignment are detected using pattern recognition techniques. The processor 1300 processes these events and generates real-time alerts via the feedback device 1700, providing operators with immediate recommendations to prevent equipment failure.

In some embodiments, the system 1000 applies an autoencoder-based anomaly detection model to compare real-time acoustic data with pre-recorded operational baselines, improving predictive accuracy while reducing false alarms. The machine learning model 1500 continuously refines its detection criteria by differentiating normal drilling conditions from progressive component wear through real-time data acquisition. Additionally, the system 1000 can adapt its detection algorithms based on operator feedback, historical performance data, and newly acquired acoustic signatures, ensuring continuous improvement in predictive maintenance recommendations over time.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for optimizing drill operations using acoustic analysis, comprising:
one or more microphones configured to detect sound from a drill, each microphone capturing an acoustic signal generated during drilling operations;
an analog-to-digital converter electrically coupled to the one or more microphones and configured to convert the captured acoustic signals into digital data;
a processor in electronic communication with the analog-to-digital converter, the processor configured to execute instructions stored in a non-transitory memory storage;
the non-transitory memory storage comprising instructions which, when executed by the processor, cause the processor to:
execute a machine learning model trained to analyze the digital data and identify one or more drilling conditions;
generate real-time feedback based on the identified drilling conditions;
a feedback device operably connected to the processor and configured to present the real-time feedback to an operator via at least one of:
a visual display,
an auditory alert, or
a haptic feedback mechanism.

2. The system of claim 1, wherein the machine learning model is trained using historical acoustic data correlated with optimal drilling performance metrics.

3. The system of claim 1, wherein the drilling conditions identified by the machine learning model include at least one of: optimal feed rate, rotation speed, air pressure, water pressure, hole openness, breakthrough, ground support conditions, fractures, and voids.

4. The system of claim 1, wherein the machine learning model detects an abnormal drilling condition indicative of at least one of: equipment failure, geological anomalies, or drill bit wear.

5. The system of claim 4, wherein the system is configured to provide predictive maintenance alerts based on detected acoustic signatures indicative of component wear or failure.

6. The system of claim 1, wherein the machine learning model is configured to continuously refine its analysis using real-time acoustic data to improve predictive accuracy over time.

7. The system of claim 6, wherein the machine learning model is adapted to recognize operator-specific drilling patterns and provide personalized recommendations.

8. The system of claim 1, wherein the processor executes a pre-trained machine learning model that classifies drilling conditions based on frequency spectrum analysis of the digital data.

9. The system of claim 1, further comprising a communication module in electronic communication with the processor, wherein the communication module is configured to:
transmit the real-time feedback to at least one of a remote monitoring system or an automated drilling control system; and
transmit captured acoustic data to a cloud-based storage system for further analysis and refinement of the machine learning model.

10. The system of claim 9, wherein the communication module comprises a wireless transceiver configured to transmit data to a remote drilling control interface.

11. The system of claim 9, wherein the real-time feedback is transmitted to a teleoperated drilling control system for automated adjustments to drilling parameters.

12. The system of claim 1, wherein the feedback device provides visual indicators of drilling parameter recommendations, including suggested adjustments to feed rate and rotation speed.

13. The system of claim 12, wherein the feedback device comprises an audio output configured to provide verbal or auditory alerts to an operator based on detected drilling conditions.

14. The system of claim 1, wherein the one or more microphones are positioned on tripods adjacent to the drill and are independent of the drill structure.

15. The system of claim 1, wherein the system operates without requiring physical retrofitting of the drill.

16. The system of claim 1, wherein the machine learning model is configured to differentiate between various drilling environments, including ore drilling and bedrock drilling for structural foundations.

17. The system of claim 4, wherein an abnormal drilling condition is identified when the frequency spectrum of the captured acoustic signals deviates from a predefined operational range by at least a threshold value.

18. The system of claim 17, wherein the predefined operational range is established based on historical drilling data and dynamically updated using real-time machine learning analysis.

19. The system of claim 4, wherein an abnormal drilling condition is identified when the detected acoustic signature exhibits a deviation exceeding a predefined statistical threshold from a baseline operational pattern stored in the system's machine learning model.

20. The system of claim 4, wherein an abnormal drilling condition is determined when the detected acoustic signal pattern is classified as an anomaly by a trained machine learning model utilizing historical drilling data.
